(19) United States
(12) Patent Application Publication
(10) Pub. No.: US 2006/0027112 A1
(43) Pub. Date: Feb. 9, 2006

(54) Ink reservoir doctor blade

(76) Inventors: Klaus Graeler, Lengerich (DE); Guenter Rogeee, Lienen (DE)

Correspondence Address: JACOBSON HOLMAN PLLC, 400 SEVENTH STREET N.W., SUITE 600, WASHINGTON, DC, 20004, US

(21) Appl. No.: 10/529,554

(22) PCT Filed: Nov. 26, 2003
(86) PCT No.: PCT/EP03/13347

§ 371 Date: Mar. 29, 2005

(30) Foreign Application Priority Data
Nov. 28, 2002 (DE) 102 55 411.0

(51) Int. Cl. B41F 31/00

(52) U.S. Cl. 101/350.6

(57) ABSTRACT

The invention relates to a color chamber doctor blade 1, which has following characteristic features:
two doctor blade knives 2 that can be set up in a roof-like fashion against a roller 6
from which two doctor blade knives 2 can be fixed on the doctor blade chamber body 5 by means of a clamping plate 3
whereby the clamping plate 3 is in active connection with long-stretch fasteners 4 in the axial direction (z) of the roller 6,
which are arranged essentially parallel to the clamping plate 3
and from which the force required for fixing at least one doctor blade knife 2 is applied.

Inventive is that the resultant of the force exercised by the fasteners 4 points to the doctor blade chamber body 5.

The invention relates to a color chamber doctor blade according to the preamble of the claim 1.

Color chamber doctor blades have been known for a long time. The color chamber doctor blades are subject to continuous wear and therefore must be replaced regularly. As a rule, to fix them, the doctor blade knives are pressed against the doctor blade chamber body with the help of a clamping plate. For that purpose, in the past, the clamping plates were fixed with screws on the doctor blade chamber body, as shown in DE 42 41 792 A1. The clamping plate, in its turn, presses the doctor blade knife against the doctor blade chamber body and thus fixes it. However, because of the length of the doctor blade in the radial direction of the roller, which is impinged with color from the doctor blade chamber, a large number of screws must be changed when changing the doctor blades. Since all kinds of set-up times lead to machine still stand and, as a result, are expensive, various suggestions for devices have been made in the literature that permit faster exchange of the doctor blade knives. Thus, in DE 43 20 833 C1S use of rapid-action locking devices is suggested. In recent times, one finds that the aforementioned types of fixing the clamping plates of the doctor blade knives on the doctor blade chamber body are being replaced, such that
the clamping plate is in active connection with long-stretch fasteners in the axial direction (z) of the roller,
which are mounted essentially parallel to the clamping plate
and by which the force necessary for fixing at least one of the doctor blade knives is exercised,
   as maintained in the preamble of the claim 1.

Clamping plates are flexible sheet metal plates that are held by means of screws or similar means of fastening on the doctor blade chamber body, however, they are not permanently fixed. Clamping is done on the side of the screws facing the roller, whereby the long-stretch fasteners in the axial direction (z) of the roller exert force on the clamping plate, which points away from the doctor blade chamber body. The clamping plate is, however, fixed on the doctor blade chamber body by the screws, so that the clamping plate buckles and exerts force on the doctor blade knife, on the side of the screws facing the roller, which is mounted on the doctor blade chamber body and thus fixes the doctor blade knife on the doctor blade chamber body. If the force exerted by the long-stretch fasteners is inhibited, force is also neither exerted on the doctor blade knife and, if applicable, on the clamping plate.

In general, the long-stretch fasteners in the axial direction (z) of the roller are rods, with a partially round cross section, which are supported rotatably in the doctor blade chamber body. Such rods are then provided with a recess or a projection, which leads to it that, on rotation of the rod, a force is exerted, whose resultant points away from the doctor blade chamber. However, it is also possible to place an inflatable hose or an another body at that point, which can increase its volume, and in that way, exert a force on the clamping plate, whose resultant points away from the doctor blade chamber body.

Finally it should be emphasized again that the major advantage of this type of fastening is that, compared to the fixing of the doctor blade knife by loosening screws, significantly lesser number of objects of fastening—such as the rod for instance—need to be handled, so that it leads to significant saving of time in the changeover of the knives.

However, the described fastening systems also have their disadvantages.

As it is apparent from the above explanation and the following description of the situation, a large number of screws or similar fasteners must be pushed at least through the clamping plate for the abovementioned prefixing of the clamping plates. Therefore, the described doctor blade chambers have a number of holes and juts (screws) in the area of the clamping plates. Naturally, due to the unavoidable mass of the residues of the color exiting from the color deck, color deposits precipitate precisely on the holes and the juts (screws), which make it difficult to cleanse the machine and, to some extent, also to change the knives.

Consequently, the task of the present invention is to devise a doctor blade chamber, which can function with a lesser number of holes and juts (screws) in the area of the clamping plates.

This task is solved, in that
the resultant force exercised by the fasteners points to the doctor blade chamber body.

This measure makes the supporting function for holding the screws as implemented in the current status of the technology superfluous. The result is that the holes in the clamping plate and the juts (screws) protruding from the clamping plate are no longer necessary. Further, there are less impurities in the area of the clamping plate. In addition to that, one can dispense with the use of the spring steel sheet used in the fabrication of the clamping plates, since the pressing force necessary for fixing the doctor blade knife and its restoring force do not result from the buckling of the sheet metal plate, but ensue directly from the fasteners.

Further advantages and embodiments of the invention follow from the description of the concrete situation and the claims.

The individual figures show:

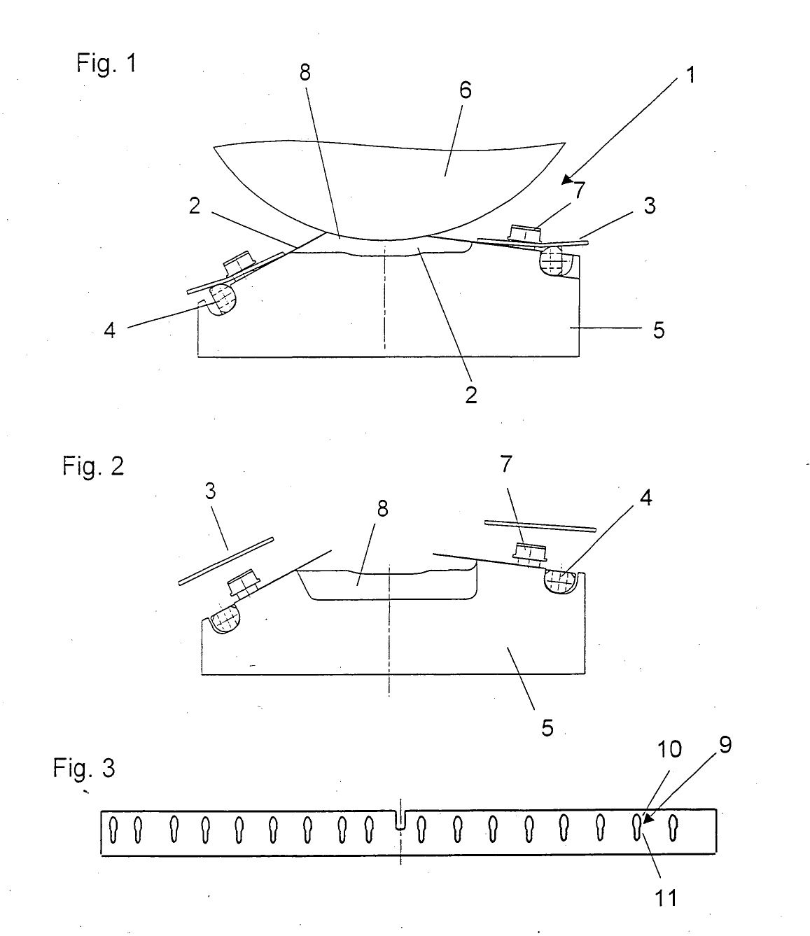

FIG. 1. A section of a doctor blade chamber in operation according to the current status of the technology

FIG. 2. A section of a doctor blade chamber taken out from the roller according to current status of technology

FIG. 3. Top view of a clamping plate according to the current status of the technology

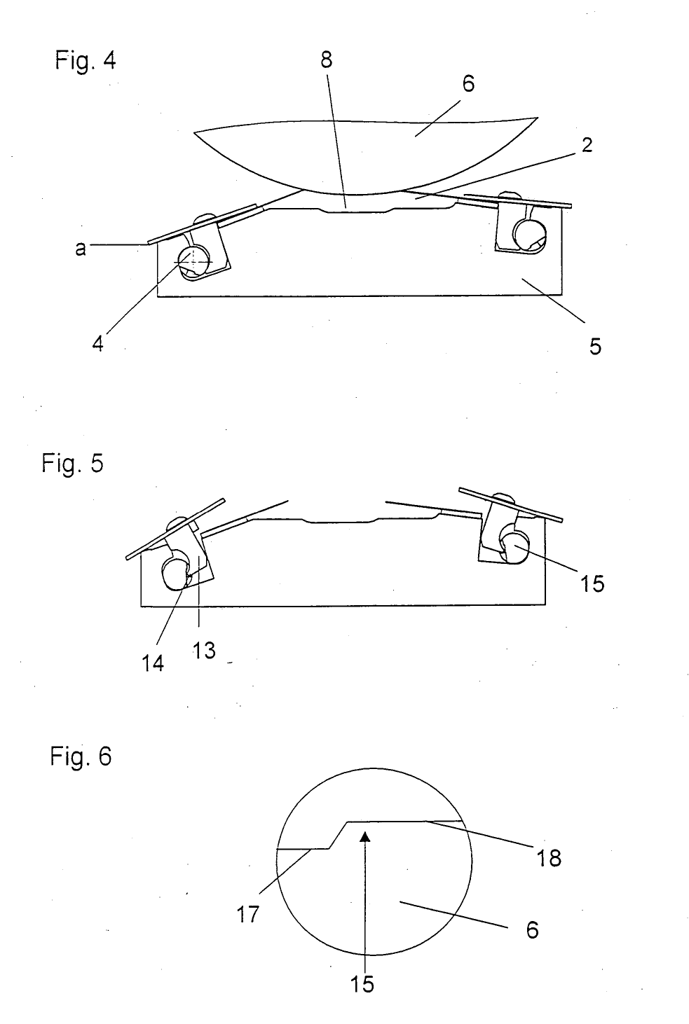

FIG. 4. A section of a doctor blade chamber in operation according to the invention

FIG. 5. A section of a doctor blade chamber taken out from the roller according to the invention

FIG. 6 An enlarged view of a cross section of the rod 4

FIG. 1 shows a color chamber doctor blade 1 according to the current status of the technology. As is known, in case of the color chamber doctor blades 1, the color chamber 8 is limited by the roller 6 to be colored of the doctor blade chamber body 5, whereby 5 can obviously also consist of several parts, and the doctor blade knives 2. As adequately detailed in the introductory description, the two doctor blade knives 2 of the color chamber doctor blades 1 are each fixed by means of a clamping plate 3, which presses the 3 respective doctor blade knives against the doctor blade chamber body 5. The force required for this is the restoring force of the clamping plate, which arises, because the clamping plate is buckled between the long-stretch fastening element 4, which is represented in this case by the rod, and the head of the screw 7 and the doctor blade chamber body 5.

As already mentioned, the resultant force, which the rod 4 exerts on the clamping plate, points away from the doctor blade chamber. This force arises because the rod 4 is provided with a recess 16 that is at the same level with the surface of the doctor blade chamber body 5 during the loading of the clamping plate 3 as shown in FIG. 2. Thus the rotation of the rod 4 brings the circular part of the peripheral area of the mainly cylindrically shaped rod 4 in contact with the clamping plate 3, the contacted part of the clamping plate is pressed outside and the previously described restoring force of the plate 3 fixes the doctor blade knife.

FIG. 3 shows a clamping plate, which is suitable for use in the doctor blade chamber shown in FIGS. 1 and 2.

The round holes 10 and the slots 11 form the openings 9. Thereby, the diameter of the holes 10, together with the necessary play, is matched with the head of the screw 7, while the width of the slot 11 is matched to the diameter of the neck of the screws. If the clamping plate is to be removed from its operating position, the clamping plate is at first loosened by turning the rod 4 in such a fashion that the recess comes in contact with the plate 3. Since no force or lateral buckling action on the clamping plate 4 ensues from the rod 4 now, it is held only loosely by the screws 7. As a result, the plate is brought from its operating position, in which the necks of the screws grip through the grooves 11, into the removal position, thus enabling the heads of the screws 7 to slide out through the holes 10 of the clamping plate 3 for the removal.

FIGS. 4 and 5 show a chamber doctor blade according to the invention, in which the clamping plates 3 are provided with a top piece 13, which includes a joining element 14. The joining element is matched according to the recess 15 of the rod 4. The form of the recess 15 is shown once again in FIG. 6. While mounting the clamping plate 3 and the top piece 13, the joining element slides along the surface 18 of the rod 4. On striking the joining element on the recess 15 of the rod 4, the rod 4 can be turned into the clamping position. After loading the knife, the knife is clamped by rotating the rod 4. When rotating the rod 4 into the closing direction, represented by the arrow 20, first the joining element slides along the even surface 18 of the recess 15, to be subsequently carried along by the shoulder 17 of the recess. The unit consisting of the top piece 13 and the clamping plate 3 is thus brought into the position suitable for fixing the doctor blade knife 2.

FIG. 6 shows the top view of the clamping plate 3 which is used in the chamber doctor blades according to the invention shown in FIGS. 4 and 5.

List of Reference Symbols

| | |
|---|---|
| 1 | Color chamber doctor blade |
| 2 | Doctor blade knife |
| 3 | Clamping plate |
| 4 | Fastening element |
| 5 | Color chamber body |
| 6 | Roller |
| 7 | Screw |
| 8 | Color chamber |
| 9 | Opening |
| 10 | Hole |
| 11 | Slot |
| 12 | |
| 13 | Top piece |
| 14 | Joining element |
| 15 | Recess |
| 16 | Recess |
| 17 | Shoulder |
| 18 | Area |
| 19 | Arrow |

1. Color chamber doctor blade (1)
with two doctor blade knives (2) that can be set up in roof-like fashion against a roller (6)
from which both the doctor blade knives (2) can be fixed on the doctor blade chamber body (5) by a clamping plate (3)
and the clamping plate (3) is in active connection with the long fasteners (4) stretching in the axial direction (z) of the roller (6),
which are arranged essentially parallel to the clamping plate (3)
and from which the force required for fixing at least one doctor blade knife (2) is applied
characterized in that
the resultant of the forces applied by the fasteners (4) points to the doctor blade chamber body (5).

2. Color chamber doctor blade (1) according to claim 1, characterized in that the clamping plate (3) is equipped with at least one specially shaped top piece (13), which forms an active connection with the long-stretch fasteners (4) in the axial direction (z) of the roller (6).

3. Color chamber doctor blade (1) according to claim 1, characterized in that
the fasteners (4) are built with at least one inflatable hose,
the variation in the volume of which provides the force required for fixing the two doctor blade knives (2).

4. Color chamber doctor blade (1) according to claim 1, characterized in that
the fasteners (4) are built with at least one rod (4),
through the movement of which relative to the color chamber doctor blade (1), the force required for fixing at least one doctor blade knife (2) can be provided.

5. Color chamber doctor blade (1) according to claim 4, characterized in that the relative movement of the rod (4) consists of a rotation around its principal axis of inertia.

6. Color chamber doctor blade (1) according to claim 5, characterized in that
the rod (4) has an essentially round cross sectional area,
which has a recess (15) suitable for clamping the clamping plate (3) or its top piece (13).

7. Color chamber doctor blade (1) according to claim 6, characterized in that the rod (4) is fixed rotatably in the doctor blade chamber body (5).

8. Color chamber doctor blade (1) according to claim 7, characterized in that the top piece (13) has a joining element (14), which can be inserted into the recess (15) of the cross sectional area of the rod (4).

9. Color chamber doctor blade (1) according to claim 8, characterized in that the length of the top piece (13), the position of the joining element (14) on the top piece (13) and the positions of the rod (4) and the recess (15) are adjusted with each other in such a way
that the joining element (14) of the clamping plate (3) located outside the doctor blade chamber (8) can be inserted in a form-fitting manner into the recess (15) at the beginning of the process of fixing of the doctor blade knife and
that the rotation of the rod (4) required for fixing the doctor blade knife (2) conveys the joining element (14) and the clamping plate (3) into the position (a) suitable for fixing.

10. Process for the fixing of a doctor blade knife (2) of a color chamber doctor blade (1) according to claim 1.
